(19) United States
(12) Patent Application Publication
(10) Pub. No.: US 2025/0249292 A1
(43) Pub. Date: Aug. 7, 2025

(54) BOOSTER PUMP BASED EFFICIENT MAINTENANCE OF SOURCE PRESSURE OF BREATHABLE AIR IN A BREATHABLE AIR SUPPLY SYSTEM

(71) Applicant: RESCUE AIR SYSTEMS, INC., San Carlos, CA (US)

(72) Inventor: Anthony J. Turiello, Westlake, TX (US)

(73) Assignee: RESCUE AIR SYSTEMS, INC., San Carlos, CA (US)

(21) Appl. No.: 18/854,672

(22) PCT Filed: Jun. 28, 2023
(86) PCT No.: PCT/US2023/026428

§ 371 Date: Oct. 7, 2024

Related U.S. Application Data
(60) Provisional application No. 63/356,996, filed on Jun. 29, 2022.

(51) Int. Cl. A62B 7/02

(52) U.S. Cl. CPC A62B 7/02

(57) ABSTRACT

A method includes implementing a booster pump as an interface between a number of air storage tanks and one or more primary source tank(s), where the number of air storage tanks is coupled to a fixed piping system and has breathable air stored therein at a first pressure, and the one or more primary source tank(s) is also coupled to the fixed piping system and serves as a source of breathable air stored therein at a second pressure. The method also includes maintaining the second pressure of the breathable air stored within the one or more primary source tank(s) above a threshold thereof in accordance with solely activating the booster pump in response to detecting, through a pressure sensor, a demand on the one or more primary source tank(s) by way of the second pressure of the breathable air stored therein dropping below the threshold.

### CLAIM OF PRIORITY

This Application is a conversion application of, and claims priority to, U.S. Provisional Patent Application No. 63/356,996 titled CLOUD-BASED FIREFIGHTING AIR REPLENISHMENT MONITORING SYSTEM, SENSORS AND METHODS filed on Jun. 29, 2022. The contents of the aforementioned application are incorporated herein by reference in entirety thereof.

### FIELD OF TECHNOLOGY

This disclosure relates generally to emergency systems and, more particularly, to a system, a device and/or a method of a booster pump based efficient maintenance of source pressure of breathable air in a breathable air supply system.

### BACKGROUND

A structure (e.g., a vertical building, a horizontal building, a tunnel, marine craft) may have a Firefighter Air Replenishment System (FARS) implemented therein. The structure may have an emergency air fill station therein to enable firefighters and/or emergency personnel inhale safe air through face-pieces of respirators or Self-Contained Breathing Apparatuses (SCBAs). Within the FARS, a number of air storage tanks with compressed breathable air therewithin may be coupled to a number of air source tanks. Pressure of the compressed breathable air within the number of air storage tanks may be required to be boosted in order to maintain pressure of breathable air within the number of air source tanks.

Over the course of satisfying a demand (e.g., during emergencies) on the air source tanks, the pressure of the compressed breathable air within the number of air storage tanks and volume thereof may reduce. Upon said pressure equaling or reducing below the pressure of the breathable air within the air source tanks, it may be impossible to fill air source tanks with the breathable air from the air storage tanks without boosting thereof. Further, in accordance with the demand, the pressure of the breathable air within the air source tanks itself may drop.

### SUMMARY

Disclosed are a system, a device and/or a method of a booster pump based efficient maintenance of source pressure of breathable air in a breathable air supply system.

In one aspect, a breathable air supply system within a structure includes a number of air storage tanks coupled to a fixed piping system within a structure and having breathable air stored therein at a first pressure, one or more primary source tank(s) also coupled to the fixed piping system and serving as a source of breathable air stored therein at a second pressure. and a booster pump as an interface between the number of air storage tanks and the one or more primary source tank(s). The booster pump maintains the second pressure of the breathable air stored within the one or more primary source tank(s) above a threshold thereof, and is solely activated in response to detecting, through a pressure sensor, a demand on the one or more primary source tank(s) by way of the second pressure of the breathable air stored therein dropping below the threshold.

The activation of the booster pump is based on the booster pump including a pilot valve whose pressure related setting drops in accordance with the second pressure dropping below the threshold, the drop in the pressure related setting of the pilot valve causing the number of air storage tanks or an emergency power system implemented within the structure to drive one or more piston(s) of the booster pump, and the breathable air in the number of air storage tanks being supplied as an input to the booster pump to boost an output pressure thereof such that the breathable air within the one or more primary source tank(s) is maintained at least at a pressure above the threshold.

In another aspect, a booster pump in a double acting, double booster configuration is disclosed. The booster pump includes a first booster pump and a second booster pump disposed above the first booster pump. The booster pump is communicatively coupled to a number of air storage tanks coupled to a fixed piping system within a structure and having breathable air stored therein at a first pressure. The booster pump is also communicatively coupled to one or more primary source tank(s) also coupled to the fixed piping system and serves as a source of breathable air stored therein at a second pressure such that the booster pump serves as an interface between the number of air storage tanks and the one or more primary source tank(s).

The interface service of the booster pump is in accordance with the booster pump maintaining the second pressure of the breathable air stored within the one or more primary source tank(s) above a threshold thereof, and the booster pump being solely activated in response to detecting, through a pressure sensor, a demand on the one or more primary source tank(s) by way of the second pressure of the breathable air stored therein dropping below the threshold. The activation of the booster pump is based on the second booster pump including a pilot valve whose pressure related setting drops in accordance with the second pressure dropping below the threshold, the drop in the pressure related setting of the pilot valve causing the number of air storage tanks or an emergency power system implemented within the structure to drive one or more piston(s) of the booster pump, and the breathable air in the number of air storage tanks being supplied as an input to the booster pump to boost an output pressure thereof such that the breathable air within the one or more primary source tank(s) is maintained at least at a pressure above the threshold.

In yet another aspect, a method of a breathable air supply system within a structure includes implementing a booster pump as an interface between a number of air storage tanks and one or more primary source tank(s), where the number of air storage tanks is coupled to a fixed piping system within the structure and has breathable air stored therein at a first pressure, and the one or more primary source tank(s) is also coupled to the fixed piping system and serves as a source of breathable air stored therein at a second pressure. The method also includes maintaining, through the booster pump, the second pressure of the breathable air stored within the one or more primary source tank(s) above a threshold thereof in accordance with solely activating the booster pump in response to detecting, through a pressure sensor, a demand on the one or more primary source tank(s) by way of the second pressure of the breathable air stored therein dropping below the threshold.

The activation of the booster pump is based on implementing a pilot valve in the booster pump whose pressure related setting drops in accordance with the second pressure dropping below the threshold, causing the number of air storage tanks or an emergency power system implemented within the structure to drive one or more piston(s) of the booster pump consequent to the drop in the pressure related setting of the pilot valve, and supplying the breathable air in the number of air storage tanks as an input to the booster pump to boost an output pressure thereof such that the source of breathable air within the one or more primary source tank(s) is maintained at least at a pressure above the threshold.

Other features will be apparent from the accompanying drawings and from the detailed description that follows.

### BRIEF DESCRIPTION OF THE DRAWINGS

The embodiments of this invention are illustrated by way of example and not limitation in the figures of the accompanying drawings, in which like references indicate similar elements and in which:

FIG. 1 is a schematic view of a safety system associated with a structure, according to one or more embodiments.

FIG. 2 is a schematic view of an air storage system of the safety system of FIG. 1, according to one or more embodiments.

FIG. 3 is a schematic view of a double acting configuration of a booster pump of the air storage system of FIG. 2, according to one or more embodiments.

FIG. 4 is a schematic view of a double acting, double booster configuration of the booster pump of the air storage system of FIG. 2, according to one or more embodiments

FIG. 5 is a schematic view of the double acting, double booster configuration of the booster pump of FIG. 4 with low pressure air via an emergency power system driving the booster pump, according to one or more embodiments.

FIG. 6 is an illustrative perspective view and a front view of the double acting, double booster configuration of the booster pump of FIGS. 4-5, according to one or more embodiments.

FIG. 7 is a process flow diagram detailing the operations involved in a booster pump based efficient maintenance of source pressure of breathable air in a breathable air supply system, according to one or more embodiments.

Other features of the present embodiments will be apparent from the accompanying drawings and from the detailed description that follows.

### DETAILED DESCRIPTION

Example embodiments, as described below, may be used to provide a system, a device and/or a method of a booster pump based efficient maintenance of source pressure of breathable air in a breathable air supply system. Although the present embodiments have been described with reference to specific example embodiments, it will be evident that various modifications and changes may be made to these embodiments without departing from the broader spirit and scope of the various embodiments.

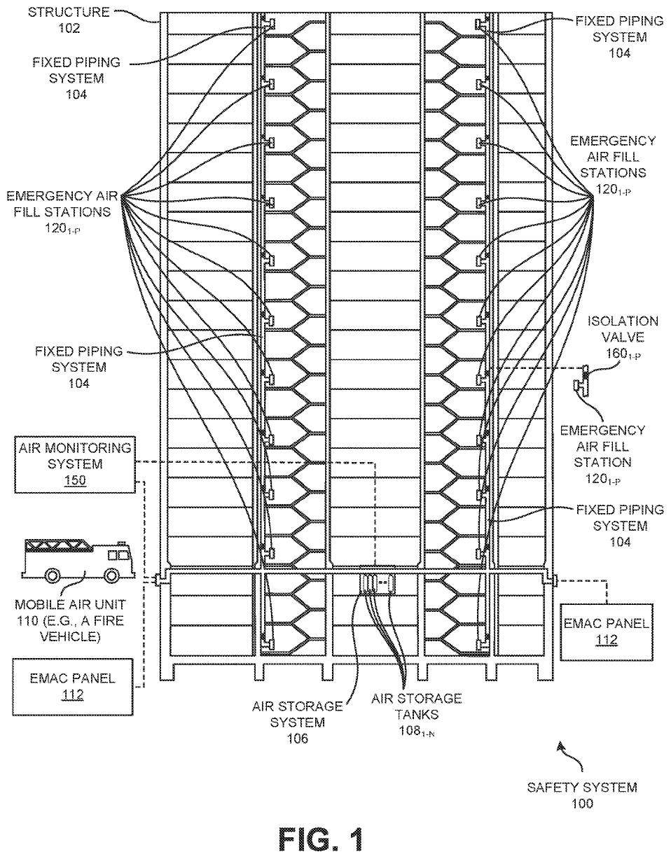

FIG. 1 shows a safety system 100 associated with a structure 102, according to one or more embodiments. In one or more embodiments, safety system 100 may be a Firefighter Air Replenishment System (FARS) to enable firefighters entering structure 102 in times of fire-related emergencies to gain access to breathable (e.g., human breathable) air in-house without the need of bringing in air bottles/cylinders to be transported up several flights of stairs of structure 102 or deep thereinto. In one or more embodiments, safety system 100 may supply air provided from a supply of air tanks (to be discussed) stored in structure 102. When a fire department vehicle arrives at structure 102 during an emergency, air supply typically may be provided through a source of air connected to said vehicle. In one or more embodiments, safety system 100 may enable firefighters to refill air bottles/cylinders thereof at emergency air fill stations (to be discussed) located throughout structure 102. Specifically, in some embodiments, firefighters may be able to fill air bottles/cylinders thereof at emergency air fill stations within structure 102 under full respiration in less than one to two minutes.

In one or more embodiments, structure 102 may encompass vertical building structures, horizontal building structures (e.g., shopping malls, hypermarts, extended shopping, storage and/or warehousing related structures), tunnels and marine craft (e.g., large marine vessels such as cruise ships, cargo ships, submarines and large naval craft, which may be “floating” versions of buildings and horizontal structures). In one or more embodiments, safety system 100 may include a fixed piping system 104 permanently installed within structure 102 serving as a constant source of replenishment of breathable air. Fixed piping system 104 may be regarded as being analogous to a water piping system within structure 102 or another structure analogous thereto for the sake of imaginative convenience.

As shown in FIG. 1, fixed piping system 104 may distribute air across floors/levels of structure 102. For the aforementioned purpose, fixed piping system 104 may distribute air from an air storage system 106 (e.g., within structure 102) including a number of air storage tanks 108_{1-N} that serve as sources of pressurized air. Additionally, in one or more embodiments, fixed piping system 104 may interconnect with a mobile air unit 110 (e.g., a fire vehicle) through an External Mobile Air Connection (EMAC) panel 112.

In one or more embodiments, EMAC panel 112 may be a boxed structure (e.g., exterior to structure 102) to enable the interconnection between mobile air unit 110 and safety system 100. For example, mobile air unit 110 may include an on-board air compressor to store and replenish pressurized/compressed air in air bottles/cylinders (e.g., utilizable with Self-Contained Breathing Apparatuses (SCBAs) carried by firefighters). Mobile air unit 110 may also include other pieces of air supply/distribution equipment (e.g., piping and/or air cylinders/bottles) that may be able to leverage the sources of breathable air within safety system 100 through EMAC panel 112. Firefighters, for example, may be able to fill air into air bottles/cylinders (e.g., spare bottles, bottles requiring replenishment of breathable air) carried on mobile air unit 110 through safety system 100.

In FIG. 1, EMAC panel 112 is shown at two locations merely for the sake of illustrative convenience. In one or more embodiments, an air monitoring system 150 may be installed as part of safety system 100 to automatically track and monitor a parameter (e.g., pressure) and/or a quality (e.g., indicated by moisture levels, carbon monoxide levels) of breathable air within safety system 100. FIG. 1 shows air monitoring system 150 as communicatively coupled to air storage system 106 and EMAC panel 112 merely for the sake of example. It should be noted that EMAC panel 112 may be at a remote location associated with (e.g., internal to, external to) structure 102. In one or more embodiments, for monitoring the parameters and/or the quality of breathable air within safety system 100, air monitoring system 150 include appropriate sensors and circuitries therein. For example, a pressure sensor (not shown) within air monitoring system 150 may automatically sense and record the pressure of the breathable air of safety system 100. Said pressure sensor may communicate with an alarm system that is triggered when the sensed pressure is outside a safety range. Also, in one or more embodiments, air monitoring system 150 may automatically trigger a shutdown of breathable air distribution through safety system 100 in case of impurity/contaminant (e.g., carbon monoxide) detection therethrough yielding levels above a safety threshold.

In one or more embodiments, fixed piping system 104 may include pipes (e.g., constituted out of stainless steel tubing) that distribute breathable air to a number of emergency air fill stations 120_{1-P} within structure 102. In one example implementation, each emergency air fill station 120_{1-P} may be located at a specific level of structure 102. If structure 102 is regarded as a vertical building structure, an emergency air fill station 120_{1-P} may be located at each of a basement level, a first floor level, a second floor level and so on. For example, emergency air fill station 120_{1-P} may be located at the end of the flight of stairs that emergency fighting personnel (e.g., firefighting personnel) need to climb to reach a specific floor level within the vertical building structure.

In one or more embodiments, an emergency air fill station 120_{1-P} may be a static location within a level of structure 102 that provides emergency personnel (e.g., firefighters) with the ability to rapidly fill air bottles/cylinders (e.g., SCBA cylinders). In one or more embodiments, emergency air fill station 120_{1-P} may be an emergency air fill panel or a rupture containment air fill station. In one or more embodiments, proximate each emergency air fill station 120_{1-P}, safety system 100 may include an isolation valve 160_{1-P} to isolate a corresponding emergency air fill station 120_{1-P} from a rest of safety system 100. For example, said isolation may be achieved through the manual turning of isolation valve 160_{1-P} proximate the corresponding emergency air fill station 120_{1-P} or remotely from air monitoring system 150. In one example implementation, air monitoring system 150 may maintain breathable air supply to a subset of emergency air fill stations 120_{1-P} through control of a corresponding subset of isolation valves 160_{1-P} and may isolate the other emergency air fill stations 120_{1-P} from the breathable air supply. It should be noted that configurations and components of safety system 100 may vary from the example safety system 100 of FIG. 1.

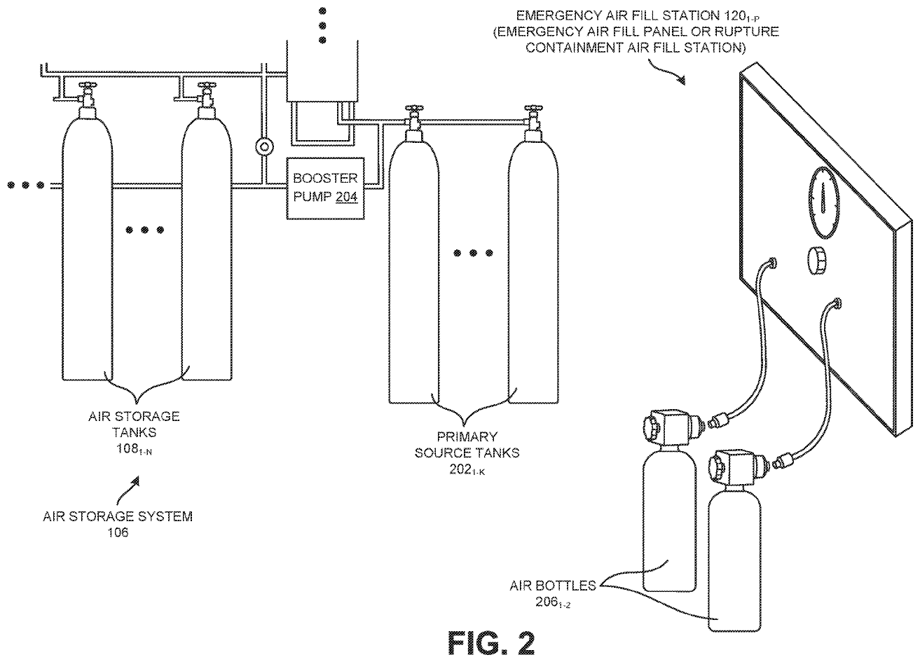

FIG. 2 shows air storage system 106, according to one or more embodiments. In one or more embodiments, as discussed above, air storage system 106 may include a number of air storage tanks 108_{1-N} serving as sources of breathable air. However, in one or more embodiments, direct utilization of air storage tanks 108_{1-N} to fill air bottles during an emergency at structure 102 may deplete the breathable air in air storage tanks 108_{1-N}. In order for breathable air at the appropriate pressure (e.g., based on a standard; 5500 Pounds per Square Inch (PSI), 4500 PSI) to fill one or more air bottles at a fill rate dictated by a regulatory requirement (e.g., a fire department requirement; an example regulatory requirement may be to fill two air bottles within two minutes or less), air storage system 106 may include one or more primary source tanks 202_{1-K} in which breathable air is maintained at the appropriate pressure discussed above. In one or more embodiments, these primary source tanks 202_{1-K} may be coupled to air storage tanks 108_{1-N} and may be utilized to fill air bottles.

In one or more embodiments, breathable air from air storage tanks 108_{1-N} may flow to primary source tanks 202_{1-K} in a regulated manner such that a pressure of breathable air within primary source tanks 202_{1-K} may be at an optimum pressure required to fill air bottles. In one or more embodiments, breathable air from primary source tanks 202_{1-K} may be distributed via fixed piping system 104 to emergency air fill stations 120_{1-P} (e.g., emergency air fill panels, rupture containment air fill stations). that may serve as static locations at which air bottles are filled. In one or more embodiments, over the course of satisfying the demand on primary source tanks 202_{1-K} with regard to filling air bottles, breathable air in air storage tanks 108_{1-N} may be depleted in terms of pressure and volume thereof. In one or more embodiments, when the pressure of breathable air in air storage tanks 108_{1-N} drops to a level equal to the pressure thereof in primary source tanks 202_{1-K} or below, it may not be possible to fill air bottles from primary source tanks 202_{1-K} without boosting the pressure of the breathable air in air storage tanks 108_{1-N} at an output of the boosting. In one or more embodiments, for the purpose of maintaining pressure of breathable air in primary source tanks 202_{1-K} to continue meeting the demand thereon and the fill rates during emergencies, a booster pump 204 may be placed between air storage tanks 108_{1-N} and primary source tanks 202_{1-K}, and an output of the abovementioned boosting through booster pump 204 may meet the pressure level requirement of the breathable air in primary source tanks 202_{1-K}.

In one or more embodiments, booster pump 204 may receive the breathable air from air storage tanks 108_{1-N} as an input thereof and pressurize the breathable air to an appropriate level (e.g., 5500 PSI, 4500 PSI) at an output thereof. In one or more embodiments, said appropriate level at the output of booster pump 204 may be a same level as a pressure level required to fill air bottles with the breathable air. FIG. 2 shows air bottles 206₁₋₂ to be filled at an emergency air fill station 120_{1-P} within structure 102. In one or more embodiments, when the pressure (and volume) of the breathable air within primary source tanks 202_{1-K} drops below a threshold, booster pump 204 may be triggered to enable reception of the breathable air from air storage tanks 108_{1-N} therethrough and pressurize said breathable air to increase and/or maintain the pressure within primary source tanks 202_{1-K} at an appropriate level. It should be noted that the pressure of breathable air within air storage tanks 108_{1-N} may be anything as long as the monitored pressure of breathable air within primary source tanks 202_{1-K} is at the appropriate level. It should be noted that both air storage tanks 108_{1-N} and primary source tanks 202_{1-K} may be coupled to fixed piping system 104 and that emergency air fill station 120_{1-P} may be coupled to primary source tanks 202_{1-K}.

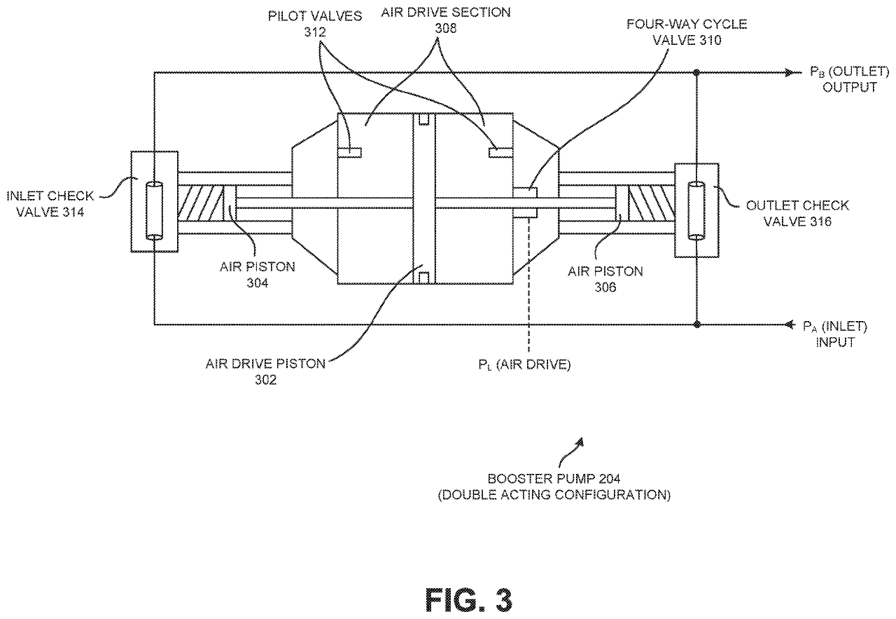

FIG. 3 shows a double acting configuration of booster pump 204, according to one or more embodiments. In one or more embodiments, booster pump 204 may include an air drive piston 302 coupled to air piston 304 and air piston 306 on either side thereof. In one or more embodiments, air piston 304 and air piston 306 may have dimensions (e.g., diameters) different from one another. In one or more embodiments, low pressure air may pneumatically drive an air drive section 308 that is swept by air drive piston 302. In one or more embodiments, the continuous, reciprocating operation may be controlled by a four-way cycle valve 310 (e.g., of the spool type), whereby four-way cycle valve 310 may drive the low pressure air toward each side of air drive piston 302 alternately. In one or more embodiments, four-way cycle valve 310 may be a 4/2 or 4/3 type cycle valve. The working of a four-way cycle valve analogous to four-way cycle valve 310 (e.g., 4/2 type, 4/3 type) is known to one skilled in the art; detailed discussion thereof has, therefore, been skipped for the sake of convenience, brevity and clarity.

In one or more embodiments, four-way cycle valve 310 may drive the low pressure air discussed above toward each side of air drive piston 302 through two pilot valves 312. In one or more embodiments, each pilot valve 312 (e.g., a 2/2 type valve) may be actuated through during the course of movement of air drive piston 302, specifically at end positions thereof. In one or more embodiments, an inlet check valve 314 and an outlet check valve 316 may support air piston 304 and air piston 306 respectively and may be associated with an input of breathable air from air storage tanks 108_{1-N} and output of pressure-boosted breathable air into primary source tanks 202_{1-K}. In one or more embodiments, an equilibrium between air drive section 308 and an outlet side may cause booster pump 204 to be stalled, whereby, at a corresponding end pressure, no further air is consumed. In one or more embodiments, booster pump 204 may automatically be triggered upon a drop in the outlet side and/or an increase in pressure at a drive side (e.g., air drive section 308) until a similar equilibrium is reached.

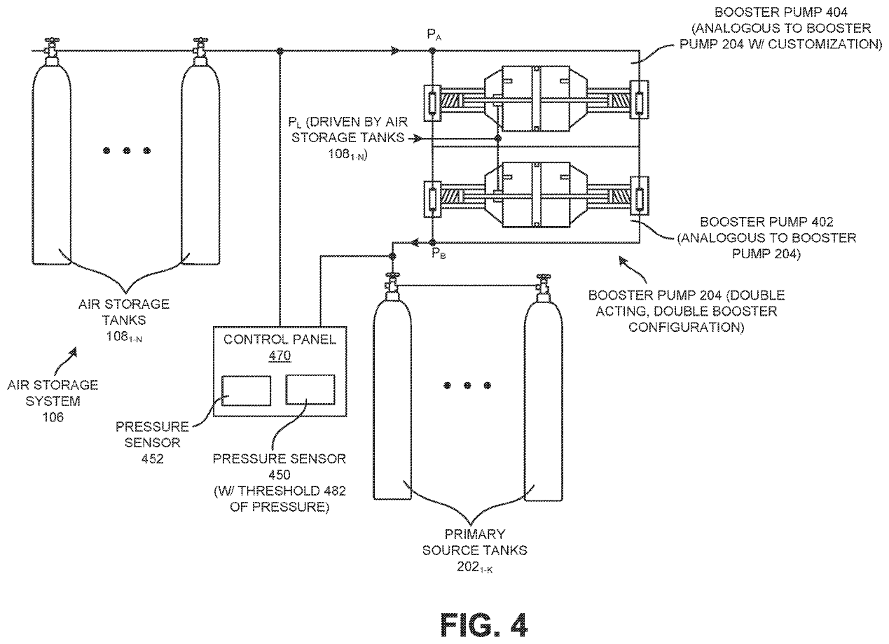

It should be noted that booster pump 204 may also be of a single acting configuration, where only one of air piston 304 and air piston 306 on one side of air drive piston 302 is required. Here, in one or more embodiments, the same four-way cycle valve 310 may be used, where one port thereof is closed all the while. Other kinds of cycle valves and the like and/or other variations in the configuration of booster pump 204 disclosed in FIG. 3 and discussed herein throughout are within the scope of the exemplary embodiments. FIG. 4 shows a double acting, double booster configuration of booster pump 204, according to one or more embodiments. In one or more embodiments, as seen in FIG. 4, booster pump 204 may include two booster pumps, viz. booster pump 402 and booster pump 404 similar to the configuration of FIG. 3, with booster pump 404 customized specifically.

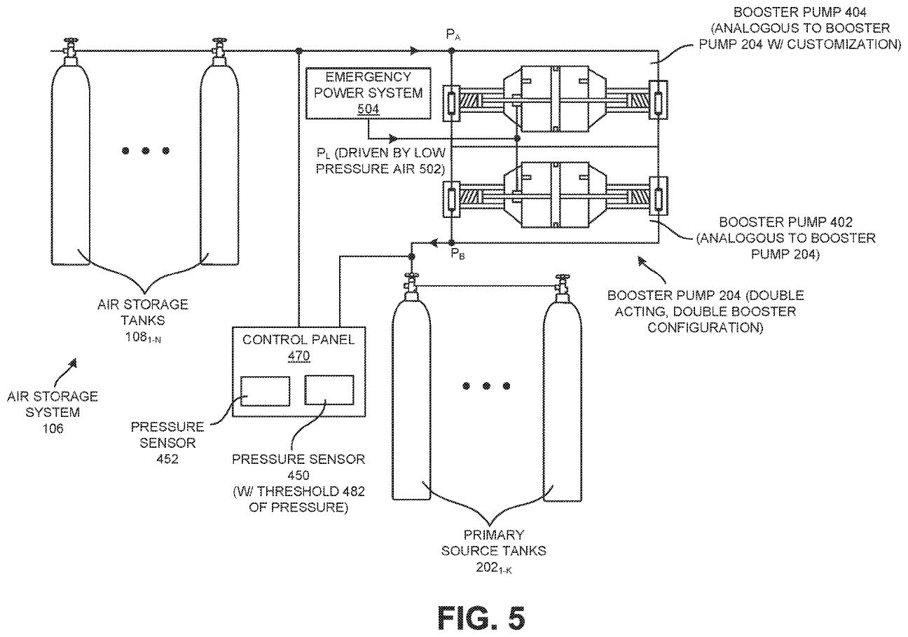

In one or more embodiments, air storage tanks 108_{1-N} may both drive booster pump 204 (e.g., one or more air drive piston(s) such as air drive piston 302; air drive pressure P_{L} is indicated in FIGS. 3-4) and provide the inlet pressure (PA) of FIGS. 3-4. In one or more embodiments, outlet pressure (PB) may be the pressure at which breathable air is supplied to primary source tanks 202_{1-K}. In one or more embodiments, breathable air in air storage tanks 108_{1-N} may be sufficient to fill air bottles 206₁₋₂ and drive one or more air drive piston(s) (e.g., air drive piston 302) of booster pump 204. FIG. 5 shows the double acting, double booster configuration of booster pump 204 with low pressure air 502 to drive the one or more air drive piston(s) thereof, according to one or more embodiments. As shown in FIG. 5, in one or more embodiments, low pressure air 502 may drive booster pump 204 (e.g., configurations of FIGS. 3-5 and wherever applicable) on power generated via an emergency power system 504 (e.g., backup power system) implemented within structure 102 of FIG. 1.

In one or more embodiments, the driving of booster pump 204 on power generated via emergency power system 504 may maximize the pressurized breathable air in air storage tanks 108_{1-N} available to primary source tanks 202_{1-K}. In one or more embodiments, if low pressure air 502 is unavailable (e.g., switched off, not in a working state), said (higher) pressurized breathable air in air storage tanks 108_{1-N} may kick in to drive the one or more air drive piston(s) of booster pump 204. Obviously, in one or more embodiments, air storage tanks 108_{1-N} may also supply breathable air through booster pump 204 to primary source tanks 202_{1-K} to enable air bottles 206₁₋₂ to be filled therefrom.

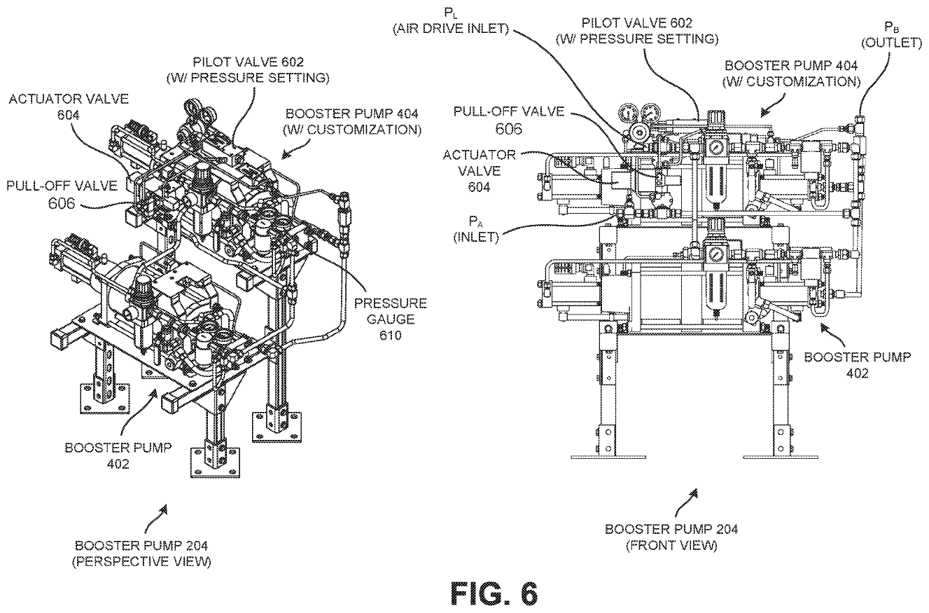

Thus, exemplary embodiments discussed herein may enable efficient use of air storage tanks 108_{1-N} through the use of low pressure air 502 to drive booster pump 204 whenever available. This may automatically enable air storage tanks 108_{1-N} to meet demands on primary source tanks 202_{1-K} better. FIG. 6 shows an implementation of the double acting, double booster configuration of booster pump 204 of FIGS. 4-5, according to one or more embodiments. In one or more embodiments, booster pump 204 may include booster pump 402 and booster pump 404, out of which booster pump 402 may have a standard configuration (e.g., the configuration of booster pump 204 in FIG. 3); booster pump 404 may be disposed above booster pump 402 that is closest to a ground level and communicatively coupled thereto. While booster pump 404 may have a configuration also similar to that of booster pump 204 of FIG. 2 or another standard configuration, some customizations may be done to suit the embodiments discussed above.

In one or more embodiments, booster pump 404 in FIG. 6 may have additional features therein as indicated through an additional pilot valve 602, an actuator valve 604 and a pull-off valve 606 thereon. Typically, breathable air from air storage tanks 108_{1-N} may leak from a booster pump analogous to booster pump 402, which depletes air storage tanks 108_{1-N}. When the leak occurs, the pressure of breathable air within primary source tanks 202_{1-K} may also drop. Additionally, in one or more embodiments, when the demand on primary source tanks 202_{1-K} increases by way of a requirement to fill air bottles (e.g., air bottles 206₁₋₂; more air bottles may be the norm rather than the exception), it may indicate the need to turn booster pump 204 including booster pump 402 and booster pump 404 on. In one or more embodiments, a pressure related to a setting of pilot valve 602 may drop with the depletion of the pressure of breathable air within primary source tanks 202_{1-K}, thereby triggering the one or more air drive piston(s) (e.g., air drive piston 302) of booster pump 204. For the aforementioned purpose, in one or more embodiments, breathable air may need to be driven into booster pump 204, which implies additional expenditures of breathable air.

Referring back to FIGS. 4-5, in one or more embodiments, booster pump 204 (e.g., including booster pump 402 and booster pump 404) may include a pressure sensor 450 communicatively coupled to primary source tanks 202_{1-K} and/or an output thereof and associated therewith. In one or more embodiments, air storage tanks 108_{1-N} may also have a pressure sensor 452 associated therewith as shown in FIGS. 4-5. Both pressure sensor 450 and pressure sensor 452 may be part of a control panel 470 associated with booster pump 204. In one or more embodiments, control panel 470 may be separate from emergency air fill station 120_{1-P} at a level of booster pump 204, air storage tanks 108_{1-N} and primary source tanks 202_{1-K} within structure 102. In one or more embodiments, as soon as the pressure sensed through pressure sensor 450 drops below a threshold 482 (e.g., 5200 PSI), pilot valve 602 may enable booster pump 204 (e.g., including booster pump 402 and booster pump 404) to be driven (e.g., through (higher) pressure breathable air within air storage tanks 108_{1-N} or low pressure air 502 through emergency power system 504) and output pressure of breathable air thereof “boosted” such that the pressure of breathable air within primary source tanks 202_{1-K} is maintained above threshold 482.

In one or more embodiments, even if pressure sensor 452 senses a low pressure of air storage tanks 108_{1-N}, booster pump 204 may still enable maintenance of the pressure of breathable air within primary source tanks 202_{1-K} to be above threshold 482. Referring back to FIG. 6, in one or more embodiments, booster pump 204 may include a pressure gauge 610 (e.g., on booster pump 404) that indicates a zero (or, default) reading when there is no demand on primary source tanks 202_{1-K}. In one or more embodiments, during an emergency (e.g., a fire at a level within structure 102), the demand on primary source tanks 202_{1-K} from emergency air fill station 120_{1-P} at the appropriate level within structure 102 may cause the pressured sensed by pressure sensor 450 to drop, thereby triggering booster pump 204 by way of actuator valve 604 that receives a signal from pilot valve 602 (e.g., whose pressure related setting also drops) to open appropriate valves (e.g., four-way cycle valve 310) within booster pump 204. In one or more embodiments, booster pump 204 may thus be driven to perform functions thereof relevant to boosting output pressure thereof and maintaining the pressure of breathable air within primary source tanks 202_{1-K} at least above threshold 482.

In one or more embodiments, as shown in FIG. 6, booster pump 204 may additionally include a pull-off valve 606, which may be a safety valve to ensure that leakage of breathable air from booster pump 204 is reduced (e.g., used for sealing purposes) and to ensure the safety of booster pump 204 and an environment thereof. Thus, in one or more embodiments, the on-demand use of booster pump 204 and the customization thereof (e.g., with additional pilot valve 602, actuator valve 604 and pull-off valve 606) as shown in FIGS. 4-6 may ensure that the leakage of breathable air from booster pump 204 is minimized.

It is to be noted that exemplary embodiments discussed herein may also involve design considerations with respect to the number of air storage tanks 108_{1-N} and the number of primary source tanks 202_{1-K}. In accordance with the fill rates required to be satisfied during emergencies, two primary source tanks 202_{1-K} for every 10-12 air storage tanks 108_{1-N} may be maintained at appropriate pressure levels through the employment of booster pump 204 as an interface therebetween. Thus, in one or more embodiments, a ratio between the number of primary source tanks 202_{1-K} and the number of air storage tanks 108_{1-N} may be 1:6 to 1:5. Implementations involving a single primary source tank (e.g., one of primary source tanks 202_{1-K}) are also within the scope of the exemplary embodiments discussed herein.

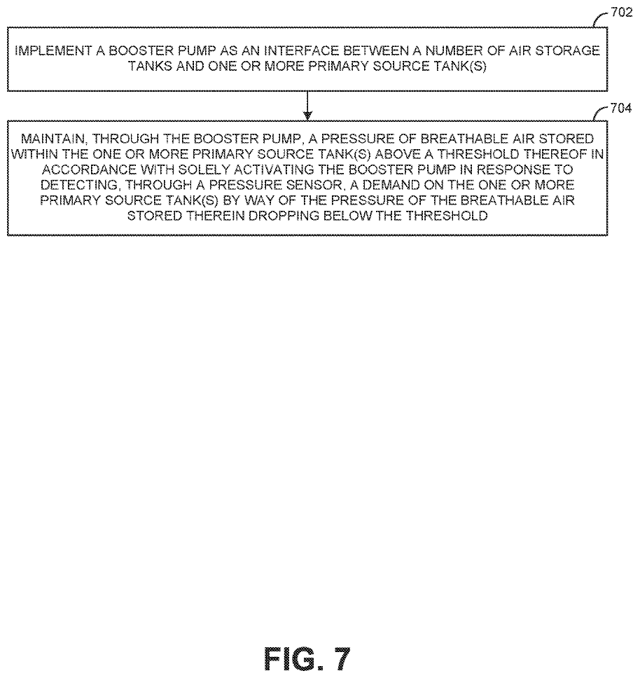

FIG. 7 shows a process flow diagram detailing the operations involved in a booster pump based efficient maintenance of source pressure of breathable air in a breathable air supply system (e.g., safety system 100) implemented within a structure (e.g., structure 102), according to one or more embodiments. In one or more embodiments, operation 702 may involve implementing a booster pump (e.g., booster pump 204) as an interface between a number of air storage tanks (e.g., air storage tanks 108_{1-N}) and one or more primary source tank(s) (e.g., primary source tanks 202_{1-K}). In one or more embodiments, the number of air storage tanks may be coupled to a fixed piping system (e.g., fixed piping system 104) within the structure and may have breathable air stored therein at a first pressure. In one or more embodiments, the one or more primary source tank(s) may also be coupled to the fixed piping system and may serve as a source of breathable air stored therein at a second pressure.

In one or more embodiments, operation 704 may then involve maintaining, through the booster pump, the second pressure of the breathable air stored within the one or more primary source tank(s) at least at a pressure above a threshold (e.g., threshold 482) thereof in accordance with solely activating the booster pump in response to detecting, through a pressure sensor (e.g., pressure sensor 450), a demand on the one or more primary source tank(s) by way of the second pressure of the breathable air stored therein dropping below the threshold.

In one or more embodiments, operation 704 may be based on implementing a pilot valve (e.g., pilot valve 602) in the booster pump whose pressure related setting drops in accordance with the second pressure dropping below the threshold, causing the number of air storage tanks or an emergency power system implemented within the structure to drive one or more piston(s) (e.g., air drive piston 302) of the booster pump consequent to the drop in the pressure related setting of the pilot valve, and supplying the breathable air in the number of air storage tanks as an input to the booster pump to boost an output pressure thereof such that the source of breathable air within the one or more primary source tank(s) is maintained at least at the pressure above the threshold. All reasonable variations are within the scope of the exemplary embodiments discussed herein.

Although the present embodiments have been described with reference to specific example embodiments, it will be evident that various modifications and changes may be made to these embodiments without departing from the broader spirit and scope of the various embodiments.

A number of embodiments have been described. Nevertheless, it will be understood that various modifications may be made without departing from the spirit and scope of the claimed invention. In addition, the logic flows depicted in the figures do not require the particular order shown, or sequential order, to achieve desirable results. In addition, other steps may be provided, or steps may be eliminated, from the described flows, and other components may be added to, or removed from, the described systems. Accordingly, other embodiments are within the scope of the following claims.

The structures and modules in the figures may be shown as distinct and communicating with only a few specific structures and not others. The structures may be merged with each other, may perform overlapping functions, and may communicate with other structures not shown to be connected in the figures. Accordingly, the specification and/or drawings may be regarded in an illustrative rather than a restrictive sense.

What is claimed is:

1. A breathable air supply system within a structure comprising:
a plurality of air storage tanks coupled to a fixed piping system within a structure and having breathable air stored therein at a first pressure;
at least one primary source tank also coupled to the fixed piping system and serving as a source of breathable air stored therein at a second pressure; and
a booster pump as an interface between the plurality of air storage tanks and the at least one primary source tank such that the booster pump:
maintains the second pressure of the breathable air stored within the at least one primary source tank above a threshold thereof, and
is solely activated in response to detecting, through a pressure sensor, a demand on the at least one primary source tank by way of the second pressure of the breathable air stored therein dropping below the threshold based on:
the booster pump comprising a pilot valve whose pressure related setting drops in accordance with the second pressure dropping below the threshold,
the drop in the pressure related setting of the pilot valve causing one of: the plurality of air storage tanks and an emergency power system implemented within the structure to drive at least one piston of the booster pump, and
the breathable air in the plurality of air storage tanks being supplied as an input to the booster pump to boost an output pressure thereof such that the breathable air within the at least one primary source tank is maintained at least at a pressure above the threshold.

2. The breathable air supply system of claim 1, wherein at least one of:
the breathable air supply system is a Firefighter Air Replenishment System (FARS), and
the pressure sensor is part of a control panel within the breathable air supply system.

3. The breathable air supply system of claim 1, wherein the booster pump further comprises:
an actuator valve that receives a signal from the pilot valve to open at least one input valve of the booster pump following the drop in the pressure related setting of the pilot valve, and
a pull-off valve to reduce leakage of the breathable air from the booster pump and to ensure safety thereof.

4. The breathable air supply system of claim 1, wherein the demand on the at least one primary source tank occurs by way of at least one air cylinder being filled at an emergency air fill station within the structure at a level of the booster pump with the breathable air from the at least one primary source tank, the emergency air fill station being communicatively coupled to the at least one primary source tank.

5. The breathable air supply system of claim 1, wherein a number of the at least one primary source tank and a number of the plurality of air storage tanks are in a ratio of 1:6 to 1:5.

6. The breathable air supply system of claim 1, wherein, during unavailability of the emergency power system, the drop in the pressure related setting of the pilot valve causes the plurality of air storage tanks to drive the at least one piston of the booster pump.

7. The breathable air supply system of claim 1, wherein:
the booster pump is in a double acting, double booster configuration comprising a first booster pump and a second booster pump disposed above the first booster pump, the first booster pump and the second booster pump communicatively coupled to one another, and
wherein the second booster pump comprises the pilot valve, the actuator valve and the pull-off valve thereon.

8. A booster pump in a double acting, double booster configuration comprising:
a first booster pump; and
a second booster pump disposed above the first booster pump,
wherein the booster pump is communicatively coupled to a plurality of air storage tanks coupled to a fixed piping system within a structure and having breathable air stored therein at a first pressure, and
wherein the booster pump is also communicatively coupled to at least one primary source tank also coupled to the fixed piping system and serving as a source of breathable air stored therein at a second pressure such that the booster pump serves as an interface between the plurality of air storage tanks and the at least one primary source in accordance with the booster pump:
maintaining the second pressure of the breathable air stored within the at least one primary source tank above a threshold thereof, and
being solely activated in response to detecting, through a pressure sensor, a demand on the at least one primary source tank by way of the second pressure of the breathable air stored therein dropping below the threshold based on:
the second booster pump comprising a pilot valve whose pressure related setting drops in accordance with the second pressure dropping below the threshold,
the drop in the pressure related setting of the pilot valve causing one of: the plurality of air storage tanks and an emergency power system implemented within the structure to drive at least one piston of the booster pump, and
the breathable air in the plurality of air storage tanks being supplied as an input to the booster pump to boost an output pressure thereof such that the breathable air within the at least one primary source tank is maintained at least at a pressure above the threshold.

9. The booster pump of claim 8, further comprising an actuator valve that receives a signal from the pilot valve to open at least one input valve of the booster pump following the drop in the pressure related setting of the pilot valve.

10. The booster pump of claim 8, further comprising a pull-off valve to reduce leakage of the breathable air from the booster pump and to ensure safety thereof.

11. The booster pump of claim 8, wherein, during unavailability of the emergency power system, the drop in the pressure related setting of the pilot valve causes the plurality of air storage tanks to drive the at least one piston of the booster pump.

12. A method of a breathable air supply system within a structure comprising:
implementing a booster pump as an interface between a plurality of air storage tanks and at least one primary source tank, the plurality of air storage tanks coupled to a fixed piping system within the structure and having breathable air stored therein at a first pressure, and the at least one primary source tank also coupled to the fixed piping system and serving as a source of breathable air stored therein at a second pressure; and
maintaining, through the booster pump, the second pressure of the breathable air stored within the at least one primary source tank above a threshold thereof in accordance with solely activating the booster pump in response to detecting, through a pressure sensor, a demand on the at least one primary source tank by way of the second pressure of the breathable air stored therein dropping below the threshold based on:
implementing a pilot valve in the booster pump whose pressure related setting drops in accordance with the second pressure dropping below the threshold,
causing one of: the plurality of air storage tanks and an emergency power system implemented within the structure to drive at least one piston of the booster pump consequent to the drop in the pressure related setting of the pilot valve, and
supplying the breathable air in the plurality of air storage tanks as an input to the booster pump to boost an output pressure thereof such that the source of breathable air within the at least one primary source tank is maintained at least at a pressure above the threshold.

13. The method of claim 12, comprising the breathable air supply system being a FARS.

14. The method of claim 12, comprising the pressure sensor being part of a control panel within the breathable air supply system.

15. The method of claim 12, further comprising implementing the booster pump with an actuator valve that receives a signal from the pilot valve to open at least one input valve of the booster pump following the drop in the pressure related setting of the pilot valve.

16. The method of claim 12, further comprising implementing the booster pump with a pull-off valve to reduce leakage of the breathable air from the booster pump and to ensure safety thereof.

17. The method of claim 12, comprising the demand on the at least one primary source tank occurring by way of at least one air cylinder being filled at an emergency air fill station within the structure at a level of the booster pump with the breathable air from the at least one primary source tank, the emergency air fill station being communicatively coupled to the at least one primary source tank.

18. The method of claim 12, comprising a number of the at least one primary source tank and a number of the plurality of air storage tanks being in a ratio of 1:6 to 1:5.

19. The method of claim 12, further comprising the drop in the pressure related setting of the pilot valve causing the plurality of air storage tanks to drive the at least one piston of the booster pump during unavailability of the emergency power system.

20. The method of claim 12, comprising:
implementing the boost pump in a double acting, double booster configuration comprising a first booster pump and a second booster pump disposed above the first booster pump, the first booster pump and the second booster pump communicatively coupled to one another, and
the second booster pump comprising the pilot valve, the actuator valve and the pull-off valve thereon.
